(19) United States
(12) Patent Application Publication
(10) Pub. No.: US 2003/0178902 A1
(43) Pub. Date: Sep. 25, 2003

(54) Vibration motor of coin type

(75) Inventors: Sang Gil An, Suwon-Shi (KR); Soon Do Kweon, Seoul (KR)

Correspondence Address: DARBY & DARBY P.C., 805 Third Avenue, New York, NY, 10022, US

(73) Assignee: SAMSUNG ELECTRO-MECHANICS CO., LTD., Suwon-Shi (JP)

(21) Appl. No.: 10/323,129

(22) Filed: Dec. 19, 2002

(30) Foreign Application Priority Data
Mar. 25, 2002 (KR) 2002-16167
Dec. 10, 2002 (KR) 2002-78070

(51) Int. Cl. H02K 21/26

(52) U.S. Cl. 310/154.43

(57) ABSTRACT

The present invention relates to a vibration motor of coin type and objects of the present invention is to provide a vibration motor of coin type capable of increasing vibration generation force through increase in eccentric mass and of improving assembly efficiency while achieving compact sizing in a vibration motor.

### BACKGROUND OF THE INVENTION

1. Field of the Invention

The present invention relates to a vibration motor of coin type used as a silent calling means for a mobile communication terminal and more particularly to a vibration motor of coin type capable of increasing eccentric mass by improving inner structure of the compact sized vibration motor of coin type, and improving productivity by modifying power supply connecting structure of a terminal portion connected to power supply for automation upon assembling the vibration motor on a mobile communication terminal.

2. Background of the Related Art

Generally, vibration motor of coin type generates vibration while its rotor is rotated with being eccentric from the center and such vibration motor is manufactured in a compact type, for being installed within a cellular phone or a pager, etc.

FIG. 1 through FIG. 3 are about the general vibration motor of coin type and FIG. 1 is a plan view for a rotor molding portion formed as one body together with the rotor, positioned above an upper portion in an inside of the vibration motor, FIG. 2 is a cross-sectional view for vibration motor of coin type taken along line A-A′ of FIG. 1, FIG. 3 is a plan view representing terminal formation positioned in an lower portion of the vibration motor.

As shown in FIG. 1 and FIG. 2, a shaft 105 is installed at the center of an upper portion in a bracket 109 and a magnet of a doughnut shape 108 spaced from the shaft 105, for enclosing an outer periphery of the shaft, is installed on a front side of the bracket 109. In a space between the magnet and the shaft, a brush 111 having a bending portion comes in contact with a rectifier substrate 103 on an upper side.

Also, the rectifier substrate 103 is provided on a rear side of the rotor 102, the rotor 102 is positioned above the magnet 108, supported by a bearing 106, for turning on the shaft 105, a wiring of coil 107 is divided and formed on a front side of the rotor 102, on the rear side of which the rectifier substrate 103 is positioned, and a weight member 113 for applying eccentric force between these divided wirings of coils, is installed.

Further, generally, for connection of a lower printed circuit board 110 formed on a front side of the bracket 109 of the vibration motor of coin type with power supply, a lead wire 114, connector 115, or a FPCB connecting terminal 116 are used, and exemplary structures of those elements are shown in FIG. 3, respectively.

Lastly, an upper portion of the bracket 109 is combined with a case 101, forming a space between the upper portion and the case.

Hereinafter, operation of vibrating motor of coin type according to a related art will be described.

As shown in (A), (B), (C) of FIG. 3, if external power supply is applied to a vibration motor through a lead wire 114, a connector 115, or FPCB connecting terminal 116, current flows into a wiring of a coil 107 arranged within an eccentric rotor 102 through the brush 111 and the rectifier substrate 103, and the eccentric rotor 102 turns on the shaft 105 with a bearing 106 intervened due to the weight member 113 owing to interaction between a magnet 108 and magnetic field member constituting a case 101, whereby vibration is induced.

Such rotor 102 in the rotor molding portion should have maximized eccentric amount for providing sufficient torque. At the moment, the eccentric amount is influenced by an eccentric mass m and an eccentric distance r. But, generally, the eccentric distance r is restricted due to a trend of compact sizing in a motor, so in order to resolve this restriction, a weight member 113 constituting the eccentric mass m should be increased. In that case, however, there exist restrictions about a space due to relations with other elements.

More specifically, in a general vibration motor of coin type of a related art as shown in FIG. 2, because a magnet 108 and a brush 111 are positioned in the same side within a case 101 with a rotor 102 centered, a weight member 113 forming an eccentric mass m cannot help being installed on a front side of the rotor 102, an opposite side of the magnet 108 and the brush 111, whereby the weight member should be made narrow and long on the front side of the rotor 102 in order to avoid interference with a wiring of a coil 107. But, when the weight member 113 is made narrow and long, height of vibration motor of coin type is increased, which resultantly goes against the current trend of compact sizing in a motor.

Therefore, the weight member 113 is prepared by material of high specific gravity, but which cannot provide sufficient eccentric amount, either.

Also, in the general vibration motor of coin type, in case of reducing an outer diameter on the whole, not only reduction in the eccentric amount due to the eccentric distance r, is generated as described above, but also reduction in a space for assembling a brush 111 due to reduction in an inner diameter of a magnet, is caused. So, a space in which the brush 111 is positioned is reduced, whereby a problem of restrictions in a space is caused.

Namely, an assembly process becomes difficult and complicated due to the foregoing restrictions. The problem in the assembly process as the foregoing, is particularly problematic upon manual assembling a cellular phone using a lead wire 114, a connector 115, or a FPCB connecting terminal 116 in order to connect power supply.

Also, in case of a general vibration motor of coin type according to a related art, the brush 111 has a bending portion of “ [symbol] ”, “L” shapes in lengthwise direction, showing a problem that reliability in high performance and long life is not secured, for the bending portion is influenced by fatigue destruction.

FIG. 4 is a drawing of a brush in a general vibration motor of coin type according to a related art.

As shown in FIG. 4, a brush Ill adopted for a general vibration motor of coin type according to a related art, is configured such that elastic force of the brush coming in contact with a rectifier substrate is influenced by more than two bending portions 111a, 111b. At the moment, the elastic force of the brush changes depending on minute angle displacement of these bending portions and assembling error of the brush. Therefore, a general vibration motor of coin type according to a related art not having constant elastic force of the brush, causes a problem of short life and large noise generation upon rectification.

So, it has been tried to eliminate the bending portions 111a, 111b in order to solve such problem, but for this, an auxiliary slice should be used as far as the whole height of the vibration motor is not increased, and resultantly difficulty in design that lower structure of the vibration motor should be changed drastically, has been caused.

### SUMMARY OF THE INVENTION

An object of the invention is to solve at least the above problems and/or disadvantages and to provide at least the advantages described hereinafter.

Accordingly, one object of the present invention is to solve the foregoing problems by providing a vibration motor of coin type capable of increasing vibration generating force through eccentric mass increase by modifying motor structure as far as a height of the vibration motor of coin type is not increased very much while a diameter of the vibration motor is reduced, and capable of improving assembling efficiency by modifying a brush and a terminal portion connected to power supply, constituting a lower structure.

The foregoing and other objects and advantages are realized by a vibration motor of coin type comprising: a case forming an inner space; a shaft within the case; a rotor supported by the shaft, and having a plurality of wirings of coils, a weight member, a rectifier substrate; a magnet positioned opposite to the rotor, on one side within the case with the rotor centered; a brush positioned on the other side within the case with the rotor centered, for selectively coming in contact with the rectifier substrate.

In the meantime, it is possible to construct the case forming an inner space by dividing the case into an upper case and a lower case, therefore, one of preferred embodiment of the present invention is realized by a vibration motor of coin type comprising: an upper and a lower case forming an inner space; a shaft within the upper case and the lower case; a rotor supported by the shaft, and having a plurality of wirings of coils, a weight member, a rectifier substrate; a magnet positioned opposite to the rotor, within the case with the rotor centered; a brush positioned within the case with the rotor centered, for selectively coming in contact with the rectifier substrate.

Additional characteristic of the vibration motor of coin type according to the preferred embodiment of present invention is that the lower case is a molding portion having a yoke.

Another additional characteristic of the vibration motor of coin type according to the preferred embodiment of present invention is that the lower case is a molding portion having a printed circuit board.

Still another additional characteristic of the vibration motor of coin type according to the preferred embodiment of present invention is that the lower case is a molding portion having both a yoke and a printed circuit board.

Additional characteristic of the vibration motor of coin type according to the preferred embodiment of present invention is that the printed circuit board has a landing portion of conduction on its outer side and the landing portion of conduction is divided into at least two portions.

Another additional characteristic of the vibration motor of coin type according to the preferred embodiment of present invention is that the weight member is extended both up and down as one body, with the rectifier substrate centered.

Still another additional characteristic of the vibration motor of coin type according to the preferred embodiment of present invention is that the weight member has at least one member for a first weight member on a front side of the rectifier substrate, and at least one member for a second weight member on a rear side of the rectifier substrate.

According to another aspect of present invention, the vibration motor of coin type comprises: an upper case and a lower case forming an inner space; a shaft within the upper case and the lower case; a rotor supported by the shaft, and having a plurality of wirings of coils, a weight member, a rectifier substrate; a magnet positioned opposite to the rotor; a brush having at least one bending portion perpendicular both to lengthwise direction and to axial direction of the shaft, for selectively coming in contact with the rectifier substrate.

Additional characteristic of the vibration motor of coin type according to another aspect of present invention is that the lower case is a molding portion having a printed circuit board and the brush is connected to a landing portion on a front side of the printed circuited board, and in some cases, the vibration motor further comprises an auxiliary slice having at least one bending portion perpendicular both to a lengthwise direction of the brush and to an axial direction of the shaft, for being connected to the brush mechanically.

Another additional characteristic of the vibration motor of coin type according to another aspect of present invention is that the lower case is a molding portion having a printed circuit board and the auxiliary slice is connected to a landing portion on a front side of the printed circuit board.

According to still another aspect of present invention, the vibration motor of coin type comprises: an upper case and a lower case forming an inner space; a shaft for connecting the upper case with the lower case; a rotor supported by the shaft, and having a plurality of wirings of coils, a weight member, a rectifier substrate; a brush positioned within the lower case, for selectively coming in contact with the rectifier substrate; a pair of magnets mounted on one side of the upper case and the lower case, respectively, opposite to the rotor.

Additional characteristic of the vibration motor of coin type according to still another aspect of present invention is that a pair of the magnets is arranged such that adjacent magnets have different polarity, with opposite magnets repulsing each other.

Another additional characteristic of the vibration motor of coin type according to still another aspect of present invention is that the lower case is a molding portion having a yoke or a printed circuit board or having both a yoke and a printed circuit board.

Still another additional characteristic of the vibration motor of coin type according to still another aspect of present invention is that the weight member is extended both up and down as one body, with the rectifier substrate centered.

Further still another additional characteristic of the vibration motor of coin type according to still another aspect of present invention is that the weight member has at least one member for a first weight member on a front side of the rectifier substrate, and at least one member for a second weight member on a rear side of the rectifier substrate.

Additional characteristic of the vibration motor of coin type according to still another aspect of present invention is that the printed circuit board has a landing portion of conduction on its outer side and the landing portion of conduction is divided into at least two portions.

According to another and sill another aspects of the invention, additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a plan view of a vibration motor of coin type according to a related art;

FIG. 2 is a cross-sectional view of a vibration motor of coin type according to a related art;

FIG. 3 is a drawing of a terminal shape of a vibration motor of coin type according to a related art;

FIG. 4 is a drawing of a brush of a vibration motor of coin type according to a related art;

FIG. 5 is a cross-sectional view of a vibration motor of coin type according to the present invention;

FIG. 6 includes a plan view, a cross-sectional view, and a rear side view of a vibration motor of coin type according to the present invention;

FIG. 7 is aback side view of a lower printed board of a vibration motor of coin type according to the present invention;

FIG. 8 is a plan view of a lower printed board of a vibration motor of coin type according to the present invention; and

FIG. 9 is a drawing of a brush of a vibration motor of coin type according to the present invention.

FIG. 10 and FIG. 11 are drawings representing construction of magnets 2, 2a for increasing magnetic flux applied on a wiring of a coil 7 in the vibration motor of coin type.

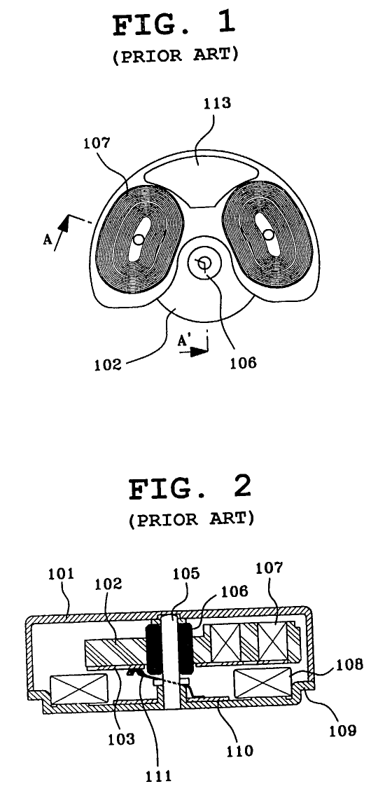

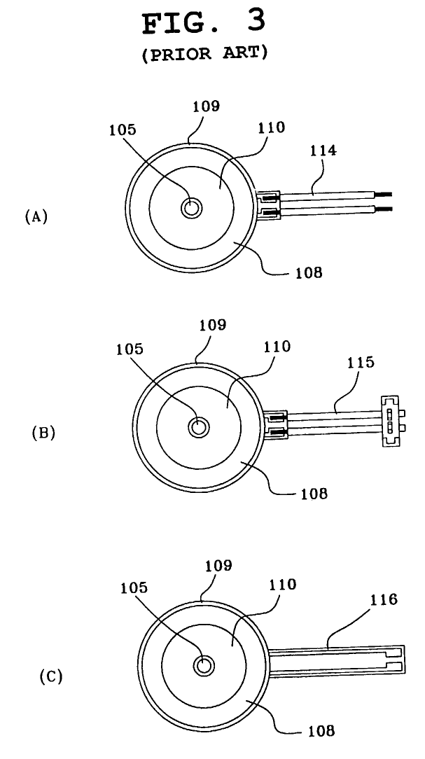

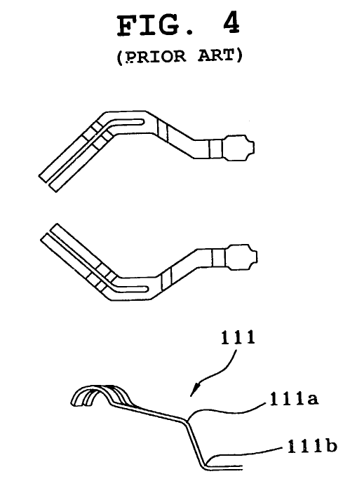

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### DETAILED DESCRIPTION OF PREFERRED EMBODIMENTS

The following detailed description will present a deflection yoke according to a preferred embodiment of the invention in reference to the accompanying drawings.

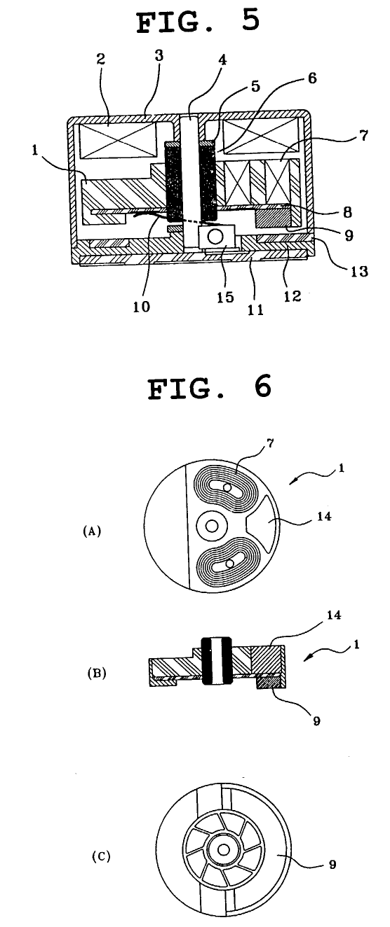

FIG. 5 is a cross-sectional view of a vibration motor of coin type according to one embodiment of the present invention and FIG. 6 includes a plan view, a cross-sectional view, a rear side view of a rotor molding portion including a rotor, in which a magnet 2 and a brush 10 are opposite each other with a rotor 1 intervened, i.e., with the rotor 1 centered. Therefore, a space or area in which the brush 10 is operated or installed is sufficiently secured and, at the same time, a space necessary for a rotor of large eccentric mass to rotate with fast velocity, is possibly secured.

A vibration motor of coin type according to the present invention, as shown in FIG. 5, comprises an upper case 3 on which a magnet 2 is attached, for forming a space portion of a predetermined size in an inside; a lower case consisting of a molding portion 12 having a yoke 13 and/or a printed circuit board 11, and a shaft 4 is positioned within the upper case and the lower case, a rotor 1 at the shaft is supported by a washer 5 and a bearing 6.

More specifically, one side of the shaft 4 is fixed in a center of the upper case 3 and the other side of the shaft 4 is fixed in the molding portion 12. Further, the rotor is supported at the shaft 4 by the washer 5 and the bearing 6 so that the rotor may be eccentric. Still further, the rotor has, in its front side, a wiring of a coil 7 for generating electromagnetic force due to interaction with the magnet 2 and a first weight member for increasing eccentric amount.

The yoke 13 is formed by insert-injection molding process together with a terminal as one body, and the rotor is consisting of a molding portion including, on its front and rear sides, a plurality of wirings of coils 7, weight members 9, 14 and a rectifier substrate 8.

The weight member is possibly extended to both up and down as one body, with the rectifier substrate 8 centered and, for more preferred embodiment of the present invention, the weight member has at least one member for a first weight member 14 on its front side of the rectifier substrate, and at least one member for a second weight member 9 on a rear side of the rectifier substrate.

Also, in the molding portion 12 forming the lower case, the printed circuit board 11 has a landing portion of conduction on its outer side and the landing portion of conduction is divided into at least two portions.

Also, the vibration motor of coin type according to the present invention comprises a brush 10 having at least one bending portion 10b perpendicular both to lengthwise direction and to axial direction of the shaft, for selectively coming in contact with the rectifier substrate 8.

Additional characteristic of the vibration motor of coin type of the present invention is that the brush 10 is connected to a landing portion on a front side of the printed circuited board 11, and in some cases, the vibration motor further comprises an auxiliary slice 15 having at least one bending portion 15b perpendicular both to a lengthwise direction of the brush and to an axial direction of the shaft, for being connected to the brush 10 mechanically.

Namely, the vibration motor of coin type according to the present invention is capable of preventing transformation due to force exerted after assembly with the help of at least one bending portion 10b formed on the brush 10, perpendicular both to lengthwise direction of the brush and to axial direction of the shaft, and at least one bending portion 15b formed on the auxiliary slice 15, perpendicular both to a lengthwise direction of the brush and to an axial direction of the shaft, thereby maintaining uniform elastic force.

Also, the slice 15 is connected to a front side of the printed circuit board 11.

In the vibration motor of coin type according to the present invention, vibration force is influenced by an eccentric mass m due to the weight member and an eccentric distance r.

In the meantime, the eccentric distance r has restrictions to a certain extent by a trend of compact sizing in motor, and the eccentric mass also has limitations to a certain extent though high specific gravity is used in order to increase the eccentric mass. Therefore, the present invention could secure sufficient eccentric mass in the rotor by installing a first weight member 14 and a second weight member 9 on a front side and a rear side of the rotor 1, respectively, as shown in FIG. 6, compared with a case of a related art where the weight member is installed on one single side. Further, the second weight member 9 on the rear side has no interference on wirings of a coils due to installation, compared with the first weight member 14 on the front side, which forms a strong point in viewpoint of space limitation, and effect of the eccentric mass increase becomes even greater. Here, the second weight member 9 could be fixed on a back side of the rectifier substrate 8 in the rotor 1 in an adhesive manner or by insert-injection molding.

FIG. 7 is a back side view of a lower printed board of the vibration motor of coin type according to the present invention, and the lower case comprises a molding portion 12 including a yoke 13, a printed circuit board 11 and the printed circuit board 11 has a landing portion of conduction 16 on its outer side, the landing portion of conduction 16 is divided into at least two.

Also, the landing portion 16 formed on the printed circuit board 11 is connected to a brush 10 or to an auxiliary slice 15 combined with the brush mechanically through direct connection by welding, or through indirect connection by soldering, whereby whole width of the motor could be reduced.

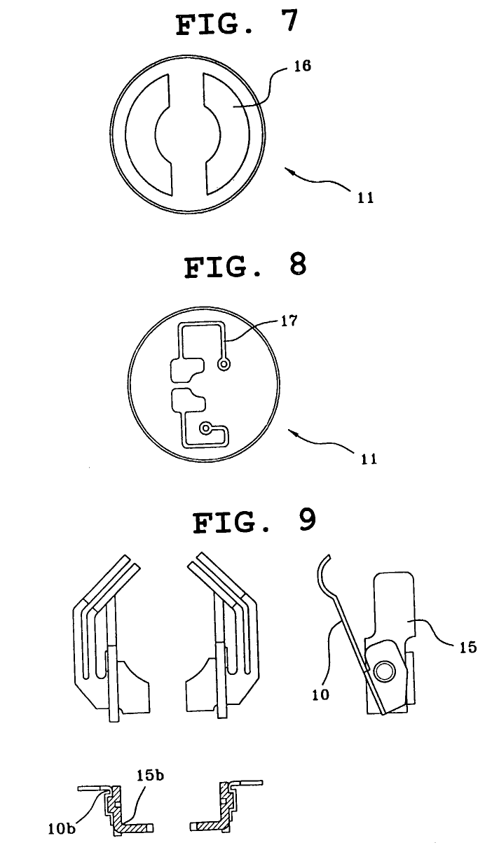

FIG. 8 is a plan view of a lower printed board of the vibration motor of coin type according to the present invention. As illustrated in FIG. 8, a pattern 17 is formed on a front side of the printed circuit board, for being combined with the brush.

Therefore, the vibration motor of coin type according to the present invention could provide the brush capable of increasing motor life and reducing noise generation upon rectification, while maintaining uniform elastic force.

FIG. 9 is a drawing of a brush of the vibration motor of coin type according to the present invention. As shown in FIG. 9, a brush 10 adopted for the vibration motor according to the present invention, is selectively connected to the rectifier substrate 8 and has at least one bending portion 10b perpendicular both to lengthwise direction and to axial direction of the shaft 4. Further, an auxiliary slice 15 has at least one bending portion 15b whose elastic force does not change very much depending on up and down displacement, and which is perpendicular both to a lengthwise direction of the brush and to an axial direction of the shaft 4, not a bending portion transformed in a direction in which force is exerted after the brush is assembled.

According to the vibration motor of coin type having the foregoing constitution, it is possible to make the motor compact sized, for a height of the vibration motor of coin type is not increased very much while a diameter of the vibration motor is reduced. Further, working efficiency is improved. Therefore, productivity and uniform quality of a product could be secured accordingly.

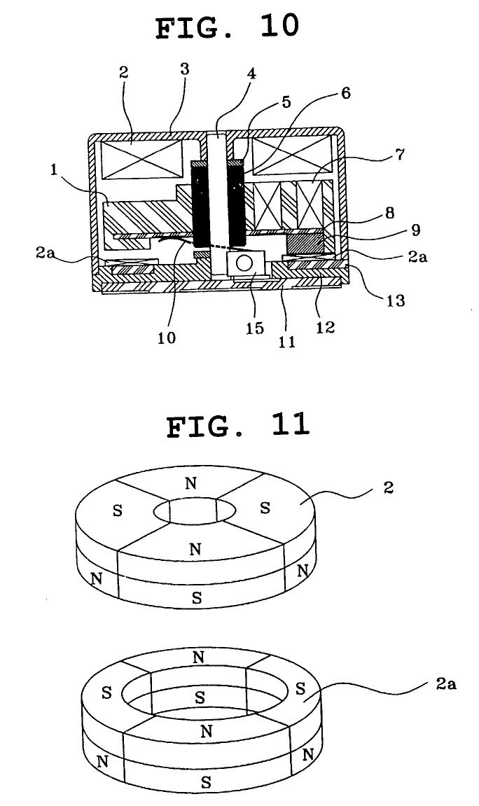

In the meantime, FIG. 10 and FIG. 11 are drawings representing construction of magnets 2, 2a for increasing magnetic flux applied on a wiring of a coil 7 in the vibration motor of coin type.

As shown in FIG. 10, a pair of magnets 2, 2a is provided up and down of a rotor 1 supported by a shaft 4, for possibly rotating, and these magnets 2, 2a are stuck on one side of an upper case 3 and a lower case, respectively.

Here, the lower case comprises a molding portion 12 including a yoke 13 and a printed circuit board 11 as is in the embodiment described above.

In the meantime, the magnet 2, 2a are of about a ring shape and have arrangement such that adjacent magnets have different polarity, with opposite magnets repulsing each other. Namely, as shown in FIG. 11, the magnets 2, 2a have arrangement such that N pole and S pole are positioned alternatively in a peripheral direction of each magnet so that adjacent magnets have different polarity, respectively.

Thanks to a pair of the magnets 2, 2a provided up and down of the rotor 1 with the rotor centered, magnetic flux applied on the wiring of the coil 7 of the rotor 1 is secured even more effectively compared with a case of single magnet structure according to a related art. Namely, the magnets 2, 2a are arranged up and down of the wiring of the coil 7, whereby the magnetic flux from these magnets 2, 2a is applied on the wiring of the coil 7 without particular loss and, resultantly, torque and vibration of the motor are improved remarkably.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art.

What is claimed is:

1. A vibration motor of coin type comprising:
a case forming an inner space;
a shaft within the case;
a rotor supported by the shaft, and having a plurality of wirings of coils, a rectifier substrate;
a magnet positioned opposite to the rotor, on one side within the case with the rotor centered; and
a brush positioned on the other side within the case with the rotor centered, for selectively coming in contact with the rectifier substrate.

2. The vibration motor of coin type according to claim 1, wherein the rotor further comprises a weight member and the weight member is extended both up and down as one body with the rectifier substrate centered.

3. The vibration motor of coin type according to claim 1, wherein the rotor further comprises a weight member and the weight member has at least one member for a first weight member on a front side of the rectifier substrate, and at least one member for a second weight member on a rear side of the rectifier substrate.

4. A vibration motor of coin type comprising:
an upper case and a lower case forming an inner space;
a shaft within the upper case and the lower case;
a rotor supported by the shaft, and having a plurality of wirings of coils, a weight member, a rectifier substrate;
a magnet positioned within the upper case, opposite to the rotor; and
a brush positioned within the lower case, for selectively coming in contact with the rectifier substrate.

5. The vibration motor of coin type according to claim 4, wherein the lower case is a molding portion having a yoke.

6. The vibration motor of coin type according to claim 4, wherein the lower case is a molding portion having a printed circuit board.

7. The vibration motor of coin type according to claim 4, wherein the lower case is a molding portion having both a yoke and a printed circuit board.

8. The vibration motor of coin type according to claim 6 or claim 7, wherein the printed circuit board has a landing portion of conduction on its outer side and the landing portion of conduction is divided into at least two portions.

9. The vibration motor of coin type according to claim 4, wherein the weight member is extended both up and down as one body, with the rectifier substrate centered.

10. The vibration motor of coin type according to claim 4, wherein the weight member has at least one member for a first weight member on a front side of the rectifier substrate, and at least one member for a second weight member on a rear side of the rectifier substrate.

11. A vibration motor of coin type comprising:
an upper case and a lower case forming an inner space;
a shaft within the upper case and the lower case;
a rotor supported by the shaft, and having a plurality of wirings of coils, a weight member, a rectifier substrate;
a magnet positioned opposite to the rotor; and
a brush having at least one bending portion perpendicular both to lengthwise direction and to axial direction of the shaft, for selectively coming in contact with the rectifier substrate.

12. The vibration motor of coin type according to claim 11, wherein the lower case is a molding portion having a printed circuit board and the brush is connected to a landing portion on a front side of the printed circuited board.

13. The vibration motor of coin type according to claim 11, further comprising an auxiliary slice having at least one bending portion perpendicular both to a lengthwise direction of the brush and to an axial direction of the shaft, for being connected to the brush mechanically.

14. The vibration motor of coin type according to claim 13, wherein the lower case is a molding portion having a printed circuit board and the auxiliary slice is connected to a landing portion on a front side of the printed circuit board.

15. A vibration motor of coin type comprising:
an upper case and a lower case forming an inner space;
a shaft for connecting the upper case with the lower case;
a rotor supported by the shaft, and having a plurality of wirings of coils, a weight member, a rectifier substrate;
a brush positioned within the lower case, for selectively coming in contact with the rectifier substrate; and
a pair of magnets mounted on one side of the upper case and the lower case, respectively, opposite to the rotor.

16. The vibration motor of coin type according to claim 15, wherein a pair of the magnets is arranged such that adjacent magnets have different polarity, with oppositely positioned magnets repulsing each other.

17. The vibration motor of coin type according to claim 15, wherein the lower case is a molding portion having a yoke.

18. The vibration motor of coin type according to claim 15, wherein the lower case is a molding portion having a printed circuit board.

19. The vibration motor of coin type according to claim 15, wherein the lower case is a molding portion having both a yoke and a printed circuit board.

20. The vibration motor of coin type according to claim 15, wherein the weight member is extended both up and down as one body, with the rectifier substrate centered.

21. The vibration motor of coin type according to claim 15, wherein the weight member has at least one member for a first weight member on a front side of the rectifier substrate, and at least one member for a second weight member on a rear side of the rectifier substrate.

22. The vibration motor of coin type according to claim 18 or claim 19, wherein the printed circuit board has a landing portion of conduction on its outer side and the landing portion of conduction is divided into at least two portions.
